(19) United States
(12) Patent Application Publication
(10) Pub. No.: US 2018/0219396 A1
(43) Pub. Date: Aug. 2, 2018

(54) System for Attaching a Portable Power Source to a Portable Computing Device

(71) Applicant: Yona Lebovitz, Monroe, NY (US)

(72) Inventor: Yona Lebovitz, Monroe, NY (US)

(21) Appl. No.: 15/885,540

(22) Filed: Jan. 31, 2018

Related U.S. Application Data
(60) Provisional application No. 62/452,456, filed on Jan. 31, 2017.

(51) Int. Cl. H02J 7/00

(52) U.S. Cl. CPC H02J 7/0042; H02J 7/0054

(57) ABSTRACT

A system for attaching a portable power source to a portable computing device recharges the portable computing device while allowing a user to operate the portable computing device. The system for attaching the portable power source to portable computing device includes a portable computing device, a portable power source, a coupling magnet, a metallic plate, and a flexible power cord. The portable computing device is a handheld electronic device with limited onboard power supply such as a smartphone or a tablet. The portable power source is a powerbank containing a lithium-ion battery that supplies electrical energy to the portable computing device. The coupling magnet and the metallic plate magnetically bond the portable computing device to the portable power source. The flexible power cord establishes electrical communication between the portable power source and the portable computing device.

The current application claims a priority to the U.S. Provisional Patent application Ser. No. 62/452,456 filed on Jan. 31, 2017.

### FIELD OF THE INVENTION

The present invention generally relates to a system for attaching a portable power source to a portable computing device. More specifically, the present invention magnetically couples the portable power source onto the portable computing device, thereby allowing the user to operate the portable computing device while it is recharging.

### BACKGROUND OF THE INVENTION

Battery pack device usage has considerably been increased over the past few years. People rely on battery pack devices to charge their mobile devices when there is no access to a power outlet. The negatives of using a battery pack is the burden of having to carry around the battery pack device along with the mobile device. The user typically will carry the battery pack device in the opposite hand not holding the mobile. At times, the user might attempt to hold both the battery pack device and mobile device in one hand, but there is risk of either the battery pack device or mobile device falling from the user's hand.

It is therefore an objective of the present invention to provide a magnetic battery kit for mobile devices which includes a magnetic pad, a metal plate, and a charging cable to mount a battery pack device onto the back of a mobile device for an easy, convenient charging experience. The metal plate may be affixed to back of the mobile device with an adhesive. The magnetic pad is placed on the battery pack, allowing the battery pack device to be secured to the metal plate affixed to the mobile device. The charging cable connects the battery pack device to the mobile device. The present invention allows the user to safely carry a battery pack device and a mobile device with one hand. The present invention can be used with any battery pack device and any mobile device.

### BRIEF DESCRIPTION OF THE DRAWINGS

FIG. 1 is a top plan exploded view of the kit components for the present invention.

FIG. 2 is a top perspective view of the present invention, illustrating the rechargeable power source in broken lines.

FIG. 3 is a top perspective exploded view of the present invention, illustrating the adhesive plate liner on the metallic plate.

FIG. 4 is a top perspective view of the present invention, illustrating the flexible power cord detached from the portable power source and the portable computing device.

FIG. 5 is a detail view of circle 5 in FIG. 4, illustrating how the flexible power cord is releasably engaged to the first socket and the second socket.

FIG. 6 is a bottom perspective exploded view of the present invention, illustrating the adhesive magnet liner on the coupling magnet.

FIG. 7 is a bottom perspective view of the present invention.

FIG. 8 is a schematic view of the present invention illustrating the electrical connections between the portable power source and the portable computing device.

### DETAILED DESCRIPTION OF THE INVENTION

All illustrations of the drawings are for the purpose of describing selected versions of the present invention and are not intended to limit the scope of the present invention.

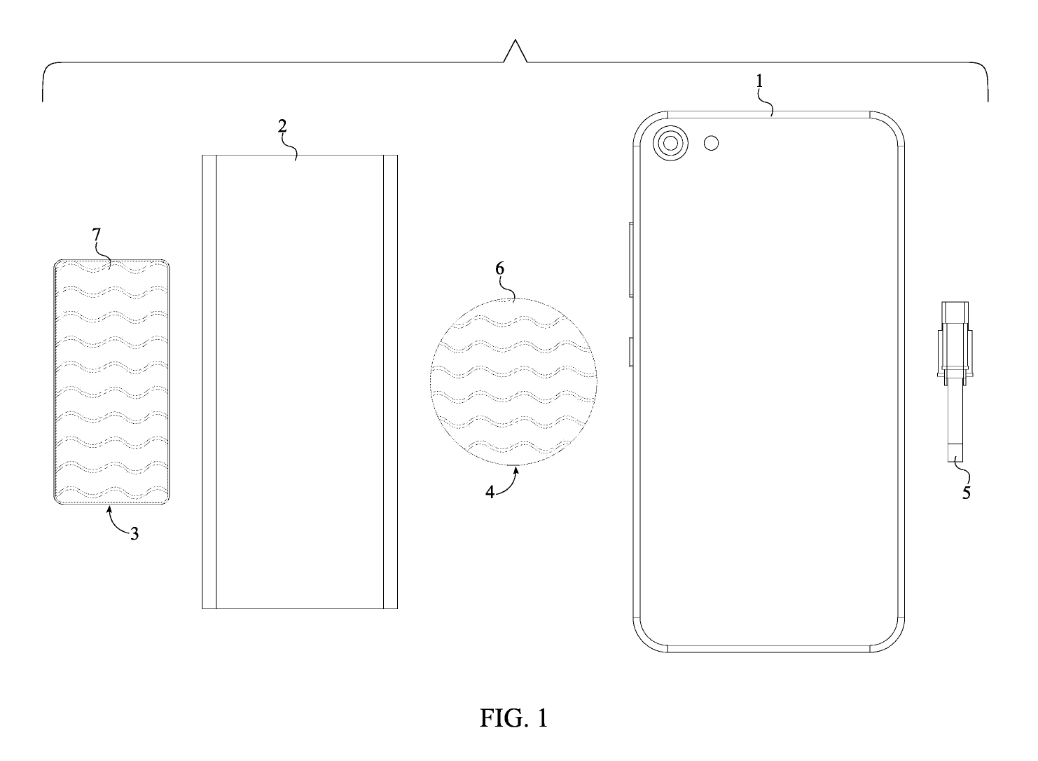

In reference to FIG. 1, the present invention is a system for attaching a rechargeable power bank to a mobile computing device such as a smartphone. More specifically, the system allows the user to operate the mobile computing device while it is being supplied electrical energy by the rechargeable power bank. Accordingly, the preferred embodiment of the present invention comprises a portable computing device 1, a portable power source 2, a coupling magnet 3, a metallic plate 4, and a flexible power cord 5. The portable computing device 1 is preferably a smartphone. Alternately, the portable computing device 1 may be a tablet or a similar handheld electronic device. In the preferred embodiment, the coupling magnet 3 and the metallic plate 4 allow the portable power source 2 to magnetically bond to the portable computing device 1. Once bonded, the flexible power cord 5 is used to establish electrical communication between the portable power source 2 and the portable computing device 1.

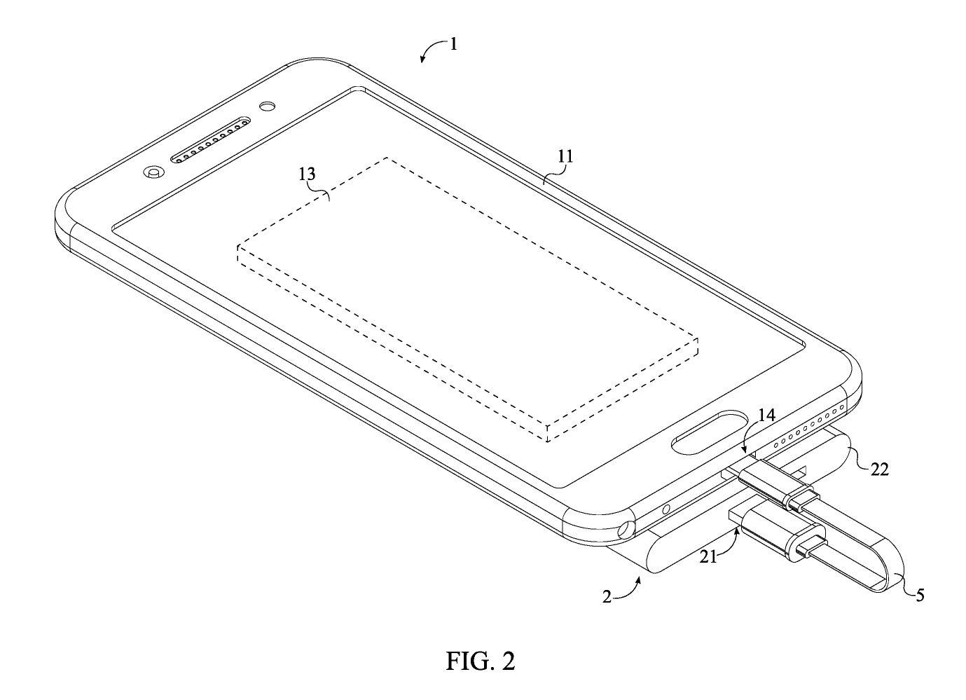

Referring to FIG. 2, the portable computing device 1 comprises a device housing 11 and a rechargeable power source 13. The device housing 11 is preferably an elongated structure designed to easily fit within the palms of the user. The rechargeable power source 13 is preferably a lithium ion battery suited for powering handheld electronic devices. Similarly, the portable power source 2 comprises a source housing 22. The source housing 22 is preferably an elongated enclosure that contains a lithium-ion battery. The source housing 22 is designed to protect the lithium-ion battery from environmental elements such as moisture. The lithium-ion battery used in the portable power source 2 preferably has a much higher capacity than the lithium-ion battery used as the rechargeable power source 13. This allows for prolonged recharging of the portable computing device 1. The rechargeable power source 13 is mounted within the device housing 11. Like the source housing 22, the device housing 11 protects the rechargeable power source 13 from environmental elements that may damage the electrical circuitry of the rechargeable power source 13.

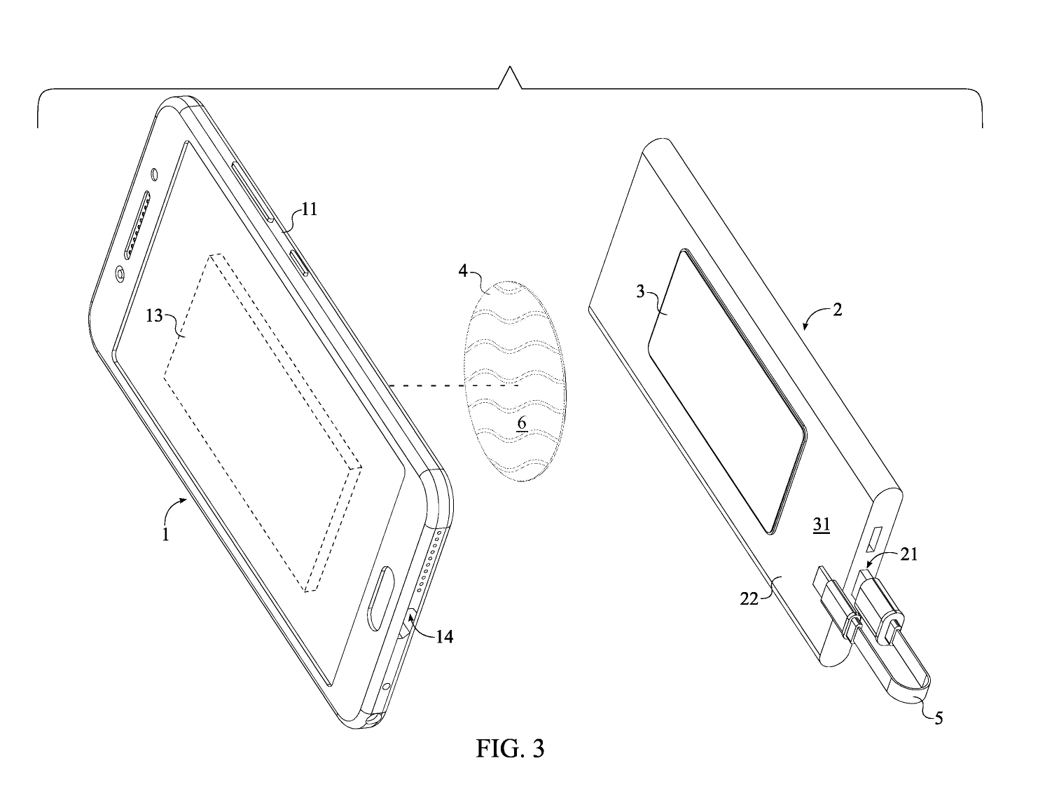

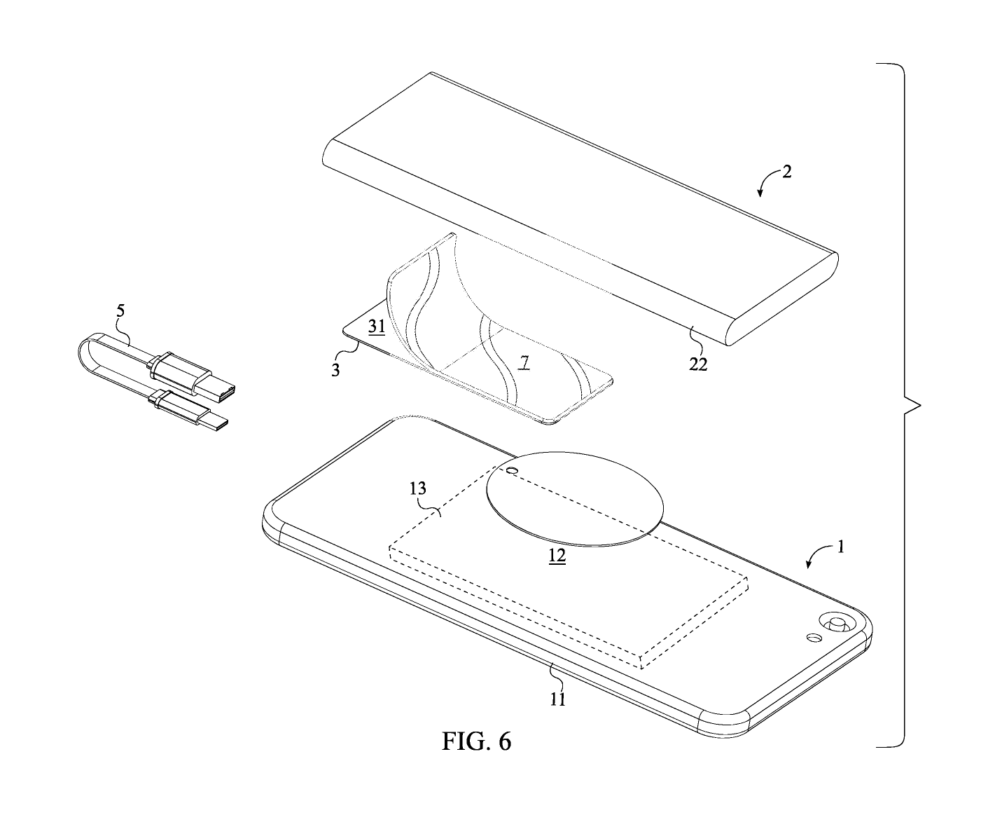

Referring to FIG. 3 and FIG. 6, in the preferred implementation, the portable power source 2 and the portable computing device 1 are stacked together in a longitudinally aligned position. To grip the portable computing device 1, the user's hand extends across the width of the portable computing device 1 with the portable power source 2 resting against the user's palm. The portable power source 2 and the portable computing device 1 are held together by the metallic plate 4 and the coupling magnet 3. As such, the metallic plate 4 is externally attached onto the device housing 11. Similarly, the coupling magnet 3 is externally attached onto the source housing 22. Stacking the portable power source 2 to the portable computing device 1 causes the metallic plate 4 and the coupling magnet 3 to directly contact each other, thereby allowing the coupling magnet 3 and the metallic plate 4 to be magnetically coupled to each other. This also creates a very strong magnetic bond that is difficult to break. The flexible power cord 5 is used to transmit electricity from the portable power source 2 to the portable computing device 1. As such, the portable power source 2 is electrically connected to the rechargeable power source 13 by the flexible power cord 5. Finally, a lateral perimeter of the source housing 22 is less than a lateral perimeter of the device housing 11. This allows user to easily hold and operate the portable computing device 1. Further, since modern smartphones are already designed to fit in the user's palm, making the portable power source 2 fit within the lateral perimeter of the portable computing device 1 doesn't increase the effective size of the present invention. Thus, the portable power source 2 along with the portable computing device 1 can easily fit inside the palm of the user.

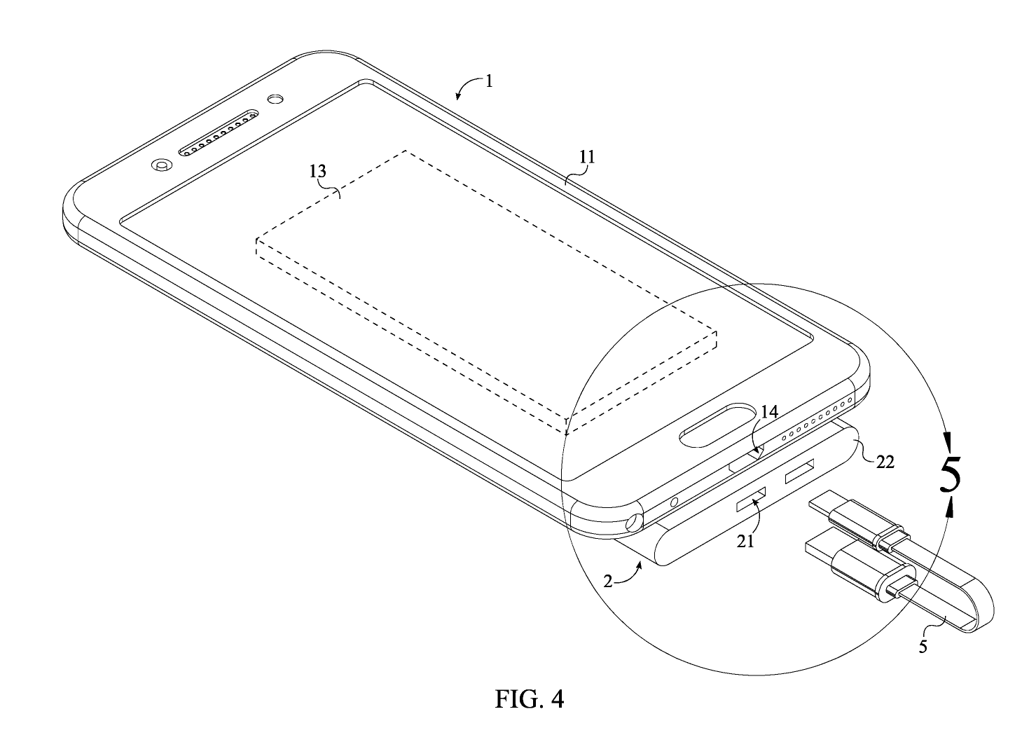

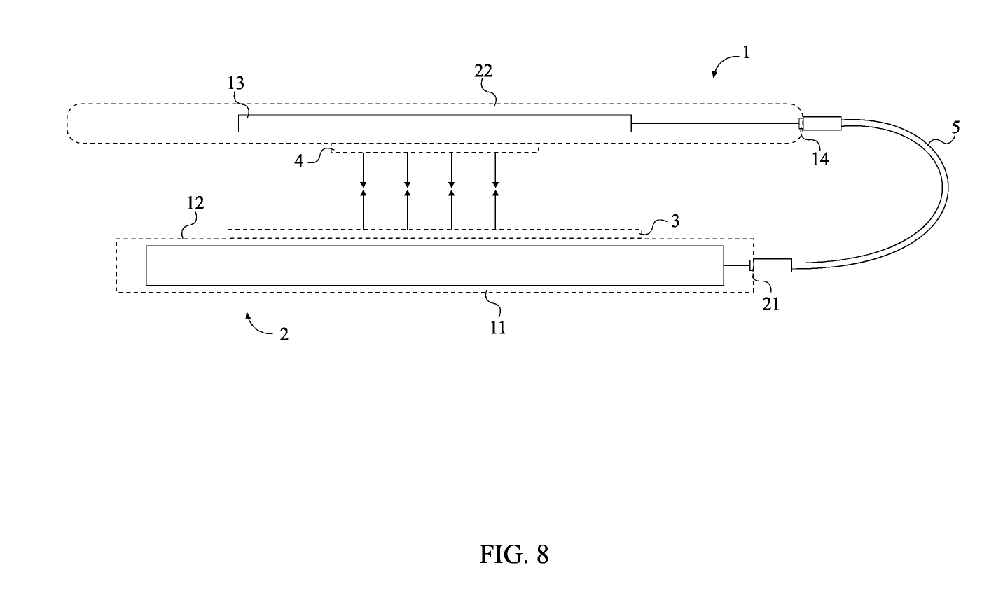

Referring to FIG. 4, the portable computing device 1 further comprises a device socket 14. Likewise, the portable power source 2 further comprises a source socket 21. The device socket 14 is preferably a micro-USB socket found in most conventional smartphones. Similarly, the source socket 21 is a USB socket capable of transmitting large amounts of electricity to the device socket 14. Alternately, the device socket 14 may be a socket capable of connecting to a widely utilized proprietary connector. The device socket 14 is laterally integrated into the device housing 11. More specifically, the preferred device socket 14 is integrated into the perimetric face of the device housing 11. Preferably, the perimetric face corresponds to the width of the device housing 11. Referring to FIG. 8, the device socket 14 is electrically connected to the rechargeable power source 13. The device socket 14 is thus able to transmit electricity into the rechargeable power source 13. Similarly, the source socket 21 is laterally integrated into the source housing 22. More specifically, the source socket 21 is integrated into a perimetric face of the source housing 22 corresponding to the width of the source housing 22. The device socket 14 and the source socket 21 are electrically connected to each other by the flexible power cord 5. To achieve this, the device socket 14 and the source socket 21 are aligned parallel and adjacent to each other. As a result, both the device socket 14 and the source socket 21 are oriented facing downwards in relation to the user. Once attached, the flexible power cord 5 hangs below the user's hand. This reduces the length of the flexible power cord 5 needed to successfully span the source socket 21 and the device socket 14, thereby preventing the flexible power cord 5 from getting tangled in the hands of the user.

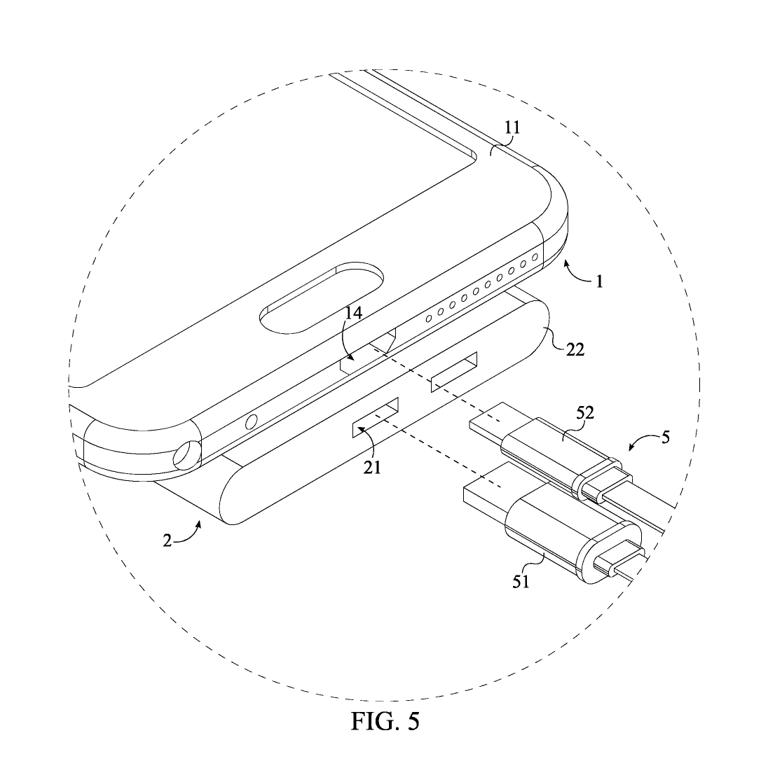

Referring to FIG. 5, the flexible power cord 5 comprises a first plug 51 and a second plug 52. In the preferred embodiment, the first plug 51 is a USB connector and the second plug 52 is a micro-USB connector. Alternately, the second plug 52 may be a widely utilized proprietary connector. The first plug 51 and the second plug 52 are positioned opposite each other along the flexible power cord 5 as a power cord electrically connects both the first plug 51 and the second plug 52. The source socket 21 and the device socket 14 are positioned near each other to reduce the overall length of the flexible power cord 5 and prevent the flexible power cord 5 from getting caught on the user's hand. The present invention also affords the user the ability to use the portable computing device 1 by itself, without being powered by the portable power source 2. Once the portable computing device 1 is completely charged, the user can simply detach the portable power source 2 and use the portable computing device 1 running on the rechargeable power source 13. As such, the flexible power cord 5 is releasably engaged to the portable power source 2 and the portable computing device 1. More specifically, the first plug 51 is releasably engaged to the source socket 21. Similarly, the second plug 52 is releasably engaged to the device socket 14.

Referring back to FIG. 3 and FIG. 6, in the preferred embodiment of the present invention, the coupling magnet 3 and the metallic plate 4 are adhered onto the portable power source 2 and the portable computing device 1, respectively. Accordingly, an adhesive plate liner 6 is provided to mount the metallic plate 4 onto the portable computing device 1. More specifically, the adhesive plate liner 6 is connected across the metallic plate 4. This allows the metallic plate 4 to be attached across a flat base 12 of the device housing 11 by the adhesive plate liner 6. Similarly, an adhesive magnet liner 7 is provided to mount coupling magnet 3 to the portable power source 2. As such, the adhesive magnet liner 7 is connected across a flat face 31 of the coupling magnet 3. The adhesive magnet liner 7 may be coated onto the flat face 31 of the coupling magnet 3 during the fabrication process. As a result, the flat face 31 of the coupling magnet 3 is attached across a flat base 23 of the source housing 11 by the adhesive magnet liner 6. This also enables the user to easily detach the portable power source 2 from the portable computing device 1 to use the portable computing device 1 as a standalone device.

Referring back to FIG. 1 and FIG. 2, the preferred embodiment of the present invention packages the portable power source 2 and the portable computing device 1 in a compact form factor that is easy to hold. As such, a lateral perimeter of the metallic plate 4 is less than the lateral perimeter of the device housing 11. This allows the device housing 11 to circumscribe metallic plate 4. Similarly, a lateral perimeter of the coupling magnet 3 is less than the lateral perimeter of the source housing 22. This allows the source housing 22 to circumscribe the coupling magnet 3. Since the preferred portable computing device 1 is a smartphone which is designed to fit comfortably within the user's hands, the portable power source 2 is configured to preserve the general formfactor of the portable computing device 1. Thus, the source housing 22 is sized smaller than the device housing 11 to enable the user to easily grip the device housing 11.

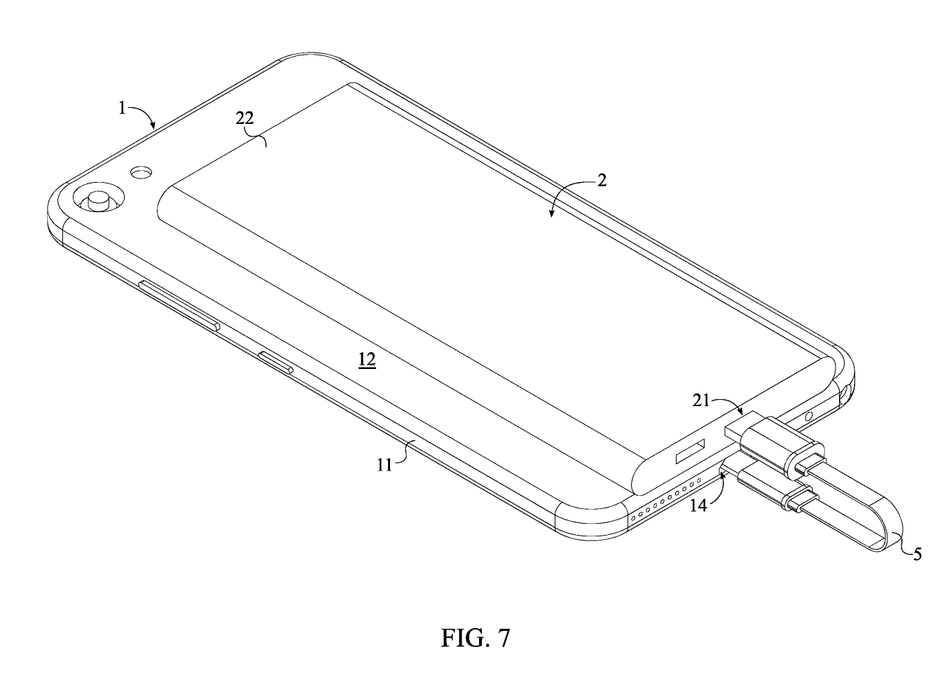

Referring to FIG. 6 and FIG. 7, in the preferred embodiment, the coupling magnet 3 is externally shaped as a rectangular prism. Similarly, the metallic plate 4 is also shaped as a rectangular prism. This allows the metallic plate 4 and the coupling magnet 3 to engage a flat shaped portable computing device 1 such as a smartphone or a tablet computer. However, the specific shape of the coupling magnet 3 and the metallic plate 4 may change in alternate embodiments, according to the shape of the portable power source 2 and the portable computing device 1. For example, the coupling magnet 3 may be either rectangular or square. The square coupling magnet 3 may accommodate a low capacity portable power source 2, whereas the rectangular coupling magnet 3 may accommodate a large capacity portable power source 2. Similarly, an alternate metallic plate 4 may also come in different shapes and sizes. For example, a metallic plate 4 may be rectangular in shape to reduce the overall footprint of the metallic plate 4 on the flat base 12 of the device housing 11.

Although the invention has been explained in relation to its preferred embodiment, it is to be understood that many other possible modifications and variations can be made without departing from the spirit and scope of the invention as hereinafter claimed.

What is claimed is:

1. A system of attaching a portable power source to a portable computing device comprises:
a portable computing device;
a portable power source;
a coupling magnet;
a metallic plate;
a flexible power cord;
the portable computing device comprises a device housing and a rechargeable power source;
the portable power source comprises a source housing;
the rechargeable power source being mounted within the device housing;
the metallic plate being externally attached onto the device housing;
the coupling magnet being externally attached onto the source housing;
the coupling magnet and the metallic plate being magnetically coupled to each other;
the portable power source being electrically connected to the rechargeable power source by the flexible power cord; and
a lateral perimeter of the source housing being less than a lateral perimeter of the device housing.

2. The system of attaching a portable power source to a portable computing device as claimed in claim 1 comprises:
the portable computing device further comprises a device socket;
the portable power source further comprises a source socket;
the device socket being laterally integrated into the device housing;
the device socket being electrically connected to the rechargeable power source;
the source socket being laterally integrated into the source housing;
the device socket and the source socket being electrically connected to each other by the flexible power cord; and
the device socket and the source socket being aligned parallel and adjacent to each other.

3. The system of attaching a portable power source to a portable computing device as claimed in claim 2 comprises:
the flexible power cord comprises a first plug and a second plug;
the first plug and the second plug being positioned opposite to each other along the flexible power cord;
the first plug being releasably engaged to the source socket; and
the second plug being releasably engaged to the device socket.

4. The system of attaching a portable power source to a portable computing device as claimed in claim 1 comprises:
an adhesive plate liner; and
the adhesive plate liner being connected across the metallic plate.

5. The system of attaching a portable power source to a portable computing device as claimed in claim 4 comprises:
the metallic plate being attached across a flat base of the device housing by the adhesive plate liner.

6. The system of attaching a portable power source to a portable computing device as claimed in claim 1 comprises:
an adhesive magnet liner; and
the adhesive magnet liner being connected across a flat face of the coupling magnet.

7. The system of attaching a portable power source to a portable computing device as claimed in claim 6 comprises:
the flat face of the coupling magnet being attached across a flat base of the source housing by the adhesive magnet liner.

8. The system of attaching a portable power source to a portable computing device as claimed in claim 1, wherein a lateral perimeter of the metallic plate being less than the lateral perimeter of the device housing.

9. The system of attaching a portable power source to a portable computing device as claimed in claim 1, wherein a lateral perimeter of the coupling magnet being less than the lateral perimeter of the source housing.

10. The system of attaching a portable power source to a portable computing device as claimed in claim 1, wherein the coupling magnet is externally shaped as a rectangular prism.

11. A system of attaching a portable power source to a portable computing device comprises:
a portable computing device;
a portable power source;
a coupling magnet;
a metallic plate;
a flexible power cord;
an adhesive plate liner;
an adhesive magnet liner;
the portable computing device comprises a device housing and a rechargeable power source;
the portable power source comprises a source housing;
the rechargeable power source being mounted within the device housing;
the metallic plate being externally attached onto the device housing;
the coupling magnet being externally attached onto the source housing;
the coupling magnet and the metallic plate being magnetically coupled to each other;
the portable power source being electrically connected to the rechargeable power source by the flexible cord;
a lateral perimeter of the source housing being less than a lateral perimeter of the device housing;
the adhesive plate liner being connected across the metallic plate; and
the adhesive magnet liner being connected across a flat face of the coupling magnet.

12. The system of attaching a portable power source to a portable computing device as claimed in claim 11 comprises:
the metallic plate being attached across a flat base of the device housing by the adhesive plate liner.

13. The system of attaching a portable power source to a portable computing device as claimed in claim 11 comprises:
the flat face of the coupling magnet being attached across a flat base of the source housing by the adhesive magnet liner.

14. The system of attaching a portable power source to a portable computing device as claimed in claim 11 comprises:
the portable computing device further comprises a device socket;
the portable power source further comprises a source socket;
the device socket being laterally integrated into the device housing;
the device socket being electrically connected to the rechargeable power source;
the source socket being laterally integrated into the source housing;
the device socket and the source socket being electrically connected to each other by the flexible power cord; and
the device socket and the source socket being aligned parallel and adjacent to each other.

15. The system of attaching a portable power source to a portable computing device as claimed in claim 14 comprises:
the flexible power cord comprises a first plug and a second plug;
the first plug and the second plug being positioned opposite to each other along the flexible power cord;
the first plug being releasably engaged to the source socket; and
the second plug being releasably engaged to the device socket.

16. The system of attaching a portable power source to a portable computing device as claimed in claim 11, wherein a lateral perimeter of the metallic plate being less than the lateral perimeter of the device housing.

17. The system of attaching a portable power source to a portable computing device as claimed in claim 11, wherein a lateral perimeter of the coupling magnet being less than the lateral perimeter of the source housing.

18. The system of attaching a portable power source to a portable computing device as claimed in claim 11, wherein the coupling magnet is externally shaped as a rectangular prism.
